(19) United States
(12) Patent Application Publication
(10) Pub. No.: US 2009/0113708 A1
(43) Pub. Date: May 7, 2009

(54) Method for joining components

(76) Inventors: Joachim Bamberg, Dachau (DE); Wilhelm Satzger, Muenchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/363,741

(22) Filed: Feb. 28, 2006

(30) Foreign Application Priority Data
Mar. 3, 2005 (DE) 10 2005 009 769.3

(51) Int. Cl. B23P 15/04

(52) U.S. Cl. 29/889.21

(57) ABSTRACT

A method for joining components, in particular for joining a rotor blade to a rotor base body in the manufacture and/or repair of an integrally bladed gas turbine rotor, is disclosed. The method includes the following steps: a) providing two components that are to be connected, i.e., joined together; b) providing a joining part; c) aligning the two components and the joining part that are to be joined together such that the joining part is arranged as an insert between the two components that are to be joined together; d) connecting the two components with the intermediate arrangement of the joining part by moving the joining part with respect to the two stationary components that are to be joined together and in particular by exerting a compression force on the joining zones between the two stationary components and the joining part via the two stationary components.

This application claims the priority of German Patent Document No. 10 2005 009 769.3, filed Mar. 3, 2005, the disclosure of which is expressly incorporated by reference herein.

### BACKGROUND AND SUMMARY OF THE INVENTION

The present invention relates to a method for joining components, in particular for joining a rotor blade to a rotor base body in the manufacture or repair of an integrally bladed gas turbine rotor.

In fabrication of gas turbines, friction welding is a widely used joining method. Friction welding is a so-called solid state welding process. In friction welding, a distinction is made between so-called linear friction welding, so-called rotary friction welding and so-called friction stir welding. In friction welding, components are joined by friction. In linear friction welding, a component is moved back and forth with a translational movement, while the other component remains stationary and is pressed with a certain force against the moving component. In doing so, the joint faces of the components to be joined together are fitted together by hot forging.

In the method for joining components by linear friction welding known from the prior art, two components that are to be joined together are moved against one another, producing friction, one component being moved back and forth with a translational movement and preferably a defined compressive pressure being applied to the joint face between the two components via the other component. If the two components that are to be joined together are brought together directly with friction, complex clamping devices are required, especially on the moving components. This may result in deformation of the components to be joined together. In addition, the frictional movement of the components to be joined together results in free joint faces in the area of the joining zone that may be exposed to possible contamination, e.g., with oxygen. This can have a negative effect on the quality of the joint. Furthermore, with the procedure known for linear friction welding from the state of the art, the component that is moved back and forth in a linear pattern must be run to an amplitude of zero at the end of the welding operation, namely in accurate alignment with the stationary component. The precision to be maintained in this process is on the order of 0.1 mm. It is difficult to comply with this precision requirement with the known masses and forces involved or it can be done only at great expense.

Against this background, the problem on which the present invention is based is to create a novel method for joining components.

According to this invention, the method includes at least the following steps: a) providing two components that are to be joined together; b) providing a joining part; c) aligning the two components that are to be joined together and the joining part such that the joining part is arranged as an insert between the two components to be joined together; d) joining the two components with the joining part arranged in between them so that the joining part is moved with respect to the two stationary components that are to be joined together and a compressive force is exerted on the joining zones between the two stationary components and the joining part via the two stationary components.

In the inventive method for joining components, the two components that are to be joined together are not moved with friction directly against one another but instead a joining part is inserted between them to serve as an intermediate part. The two components to be joined together are stationary and the joining part is moved in relation to the two components to be joined together. A compressive force is applied to the joint faces between the components that are to be joined together and the joining part and it is applied via the two stationary components. With the help of the inventive method, the two substeps of “rubbing” and “compressing” can be separated and isolated so that it is possible to work on the components with a lower clamping force. This reduces the risk of unwanted deformation of components in linear friction welding in particular. Further, the precision to be maintained in the welded joint can be implemented more easily because the joining part can remain simply standing at the end of the welding process without requiring any precise positioning of the joining part.

The joining part is preferably of such dimensions that when it is moved into the area of the stationary components, no free joint faces are formed. This minimizes the risk of contamination due to oxygen in the area of the joining zones, for example.

Owing to the machining allowance in the area of the joining part, the inventive friction welding can now also be used for repair work. This method is suitable in particular for repairing integrally bladed gas turbine rotors by replacing a damaged rotor blade with a new rotor blade.

Preferred embodiments of the present invention are derived from the following description. Exemplary embodiments of the present invention are explained in greater detail below on the basis of the drawings without being restricted to these embodiments.

### BRIEF DESCRIPTION OF THE DRAWINGS

FIG. 1 is a perspective side view of two components to be joined together in the sense of the inventive method, namely a rotor blade to be joined to a rotor base body; and

FIG. 2 is a schematic side view of the arrangement according to FIG. 1.

### DETAILED DESCRIPTION OF THE DRAWINGS

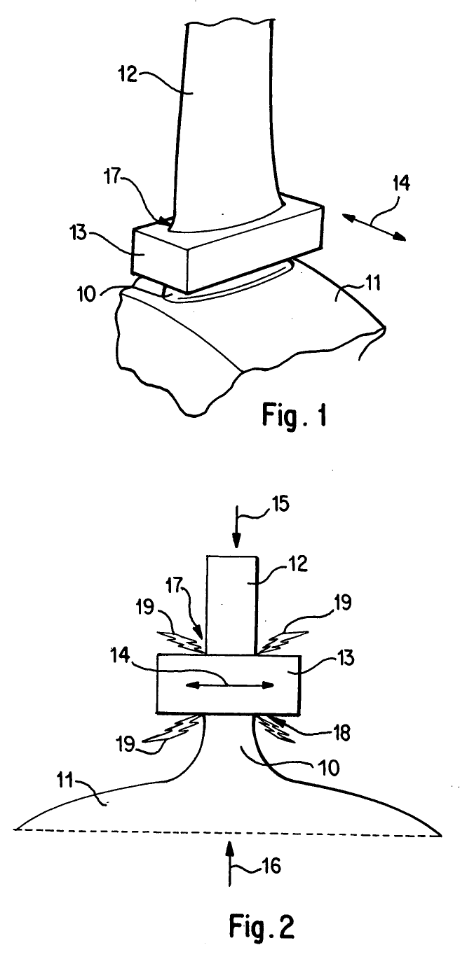

The present invention is described in greater detail below with reference to FIGS. 1 and 2.

FIGS. 1 and 2 illustrate the inventive method for joining components in the manufacture and/or repair of an integrally bladed gas turbine, whereby a blade pan 12 is to be joined to a protuberance on a rotor base body 11.

In the sense of the present invention, in addition to the two components to be joined together, namely in addition to the rotor base body 11 and the blade pan 12, a joining part 13 is also provided. For joining the blade pan 12 to the protuberance 10 on the rotor base body 11, the blade pan 12, the rotor base body 11 and the joining part 13 are aligned with one another so that the joining part 13 is arranged, i.e., positioned, between the protuberance 10 and the blade pan 12.

For joining the blade pan 12 and the rotor base body 11, the joining part 13 is moved back and forth in a translational and/or linear movement in the sense of the double arrow 14 with respect to the base body 11 and the blade pan 12, during which process both the rotor base body 11 and the blade pan 12 are stationary. In addition, in the sense of the arrows 15 and 16, a compressive force, and thus a compressive pressure, is applied via the stationary rotor base body 11 and the blade pan 12, the latter also being stationary, to the two joining zones 17 and 18 between the two components 11 and 12 which are to be joined together, and the joining part 13.

Hot forging is then performed in the area of the joining zones 17 and 18. Welding bulges 19 (so-called flash) that develop in the area of the joining zones 17 and. 18 are depicted in a highly schematic form in FIG. 2. The joining zone 17 is formed here between the blade pan 12 and the joining part 13. The joining zone 18 is between the joining part 13 and the protuberance 10 on the rotor base body 11.

Thus in the sense of the present invention, the components 11 and 12 that are to be joined, i.e., the rotor base body 11 and the blade pan 12 in the exemplary embodiment shown here, are not rubbed together directly but instead with the joining part 13 in between. The two components 11 and 12 to be joined together are thus stationary in linear friction welding. Only the joining part 13 is moved back and forth in the sense of a linear and/or translational movement in relation to the two stationary components 11 and 12. Therefore, it is possible to work with a lower clamping force in the area of the two components 11 and 12 to be joined together, namely in the area of the rotor base 11 and blade pan 12. In this way, unwanted deformation and offsetting of the blade pan 12 and the rotor base body 11 can be avoided.

The joining part 13 supplied preferably has a machining allowance such that in movement of the joining part 13, the latter protrudes on all sides in comparison with two stationary components 11 and 12 to be joined together. In movement of the joining part 13 in relation to the two stationary components 11 and 12 to be joined together, free joining faces are thus prevented in the area of the stationary components 11 and 12. In the exemplary embodiment shown here, this means that no free joint faces are formed in the area of the blade pan 12 or in the area of the protuberance 10 on the rotary base body 11 in linear and/or translational friction welding such that these free joint faces are exposed to a risk of contamination with oxygen, for example. This improves the quality of the welded joint.

The joining part 13 is preferably moved back and forth with a frequency on the order between 10 Hz and 30 Hz, especially approx. 20 Hz, with respect to the two stationary components 11 and 12. The travel of the joining part 13 is on the order of 0.1 mm to 3 mm, especially approximately 2 mm. The force required for compression is applied via the stationary components, amounting to max. 50,000 N.

In the inventive linear and/or translational friction welding, preferably the joining part 13 or joining zones 17, 18 are additionally heated and/or warmed before and/or during the frictional movement of the joining part 13. This may be accomplished by thermal radiation or inductive heating. It is thus much easier to achieve the process temperature required for welding.

It has been found that targeted heating and/or warming of the joining zones 17, 18 is possible by first passing an electric current through the joining zones before and/or during the frictional movement of the joining part 13. Since the contact resistance of the joining zones is greater than the electric resistance of the component material, the contact faces in particular, and therefore precisely the locations that are to be joined, are massively heated.

The thermal influence zones are very thin, resulting in joints that are especially vibration-proof. It may be advantageous for the input and/or output of electric current to be via the joining part 13. It is also possible to supply the electric current over one of the components 11, 12 and remove it via the other component.

As mentioned above, the joining part 13 has a machining allowance in comparison with the components to be joined together. After performing the friction welding, an after-working by material abrasion to produce the desired final contour is then performed in the area of the joining part 13.

The joining part 13 may be equipped with sensors, e.g., thermal sensors, to monitor the welding process and regulate it independently.

In FIGS. 1 and 2, the joining part 13 is moved back and forth in the direction of the double arrow 14 with respect to the rotor base body 11 and the blade pan 12 in a translational and/or linear movement in one direction running approximately perpendicular to the radial extent of the rotor base body 11 and of the blade pan 12. It should be pointed out that this direction may also run obliquely to the radial extent of the rotor base body 11 and the blade pan 12. This may be preferable for reasons of strength or manufacturing.

The inventive method is suitable for the manufacture and repair of integrally bladed gas turbine rotors. In the case when the rotor base body and the blade pan are made of a titanium-based alloy, a joining part also made of a titanium-based alloy will be used.

### LIST OF REFERENCE NUMERALS

10 Protuberance
11 Rotor base body
12 Blade pan
12 Joining part
14 Double arrow
15 Arrow
16 Arrow
17 Joining zone
18 Joining zone
19 Welding bulge, flash

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for joining components, in particular for joining a rotor blade onto a rotor base body in a manufacture and/or repair of an integrally bladed gas turbine rotor, comprising the steps of:
a) providing two components that are to be connected, i.e., joined together;
b) providing a joining part;
c) aligning the two components and the joining part that are to be joined together such that the joining part is arranged as an insert between the two components that are to be joined together; and
d) connecting the two components with the intermediate arrangement of the joining part by moving the joining part with respect to the two components which are stationary and exerting a compression force on joining zones between the two stationary components and the joining part, in particular applying this force via the two stationary components.

2. The method according to claim 1, wherein the joining part is of such dimensions that when the joining part is moved, it protrudes on all sides in comparison with the two stationary components that are to be joined together.

3. The method according to claim 1, wherein the joining part is of such dimensions that in the movement of the same, no free joint faces are formed in an area of the stationary components.

4. The method according to claim 1, wherein the joining part is moved back and forth in comparison with the two stationary components with a frequency of 10 Hz to 30 Hz, in particular with a frequency of approximately 20 Hz.

5. The method according to claim 1, wherein the joining part is moved back and forth with respect to the two stationary components with a travel of 0.1 mm to 3 mm, in particular with a travel of approximately 2 mm in comparison with the two stationary components.

6. The method according to claim 1, wherein in the manufacture and/or repair of an integrally bladed gas turbine rotor, a blade pan and a rotor base body each made of a titanium-based alloy are provided as the components to be joined together, these components being welded together via a joining part made of a titanium-based alloy.

7. The method according to claim 1, wherein the joining part or the joining zones are additionally heated and/or warmed before and/or during the frictional movement of the joining part.

8. The method according to claim 1, wherein before and/or during the frictional movement of the joining part, an electric current is passed through the joining zones.

9. The method according claim 8, wherein the electric current is supplied and removed via the joining part.

10. The method according to claim 1, wherein the components are a rotor base body and a blade pan and wherein the joining part is moved back and forth with respect to the rotor base body and the blade pan in a translational and/or linear movement in one direction running approximately perpendicular to a radial extent of the rotor base body and the blade pan.

11. The method according to claim 1, wherein the components are a rotor base body and a blade pan and wherein the joining part is moved back and forth in a translational and/or linear movement in one direction with respect to the rotor base body and the blade pan, the one direction running obliquely to a radial extent of the rotor base body and the blade pan.

12. The method according to claim 1, wherein the joining process is monitored by a sensor assigned to the joining part and is regulated independently thereof.

13. A method for joining a rotor blade to a rotor base body of a gas turbine rotor, comprising the steps of:
stationarily fixing the rotor blade;
stationarily fixing the rotor base body;
moveably positioning a joining part between the fixed rotor blade and the fixed rotor base body; and
moving the joining part with respect to the fixed rotor blade and the fixed rotor base body.

14. The method according to claim 13, further comprising the step of applying a compression force on a first joining zone between the joining part and the rotor blade and a second joining zone between the joining part and the rotor base body.

15. The method according to claim 13, wherein the joining part is moved linearly with respect to the fixed rotor blade and fixed rotor base body.

16. The method according to claim 13, wherein the joining part is arranged with respect to the fixed rotor blade and the fixed rotor base body such that the first and second joining zones are not exposed.

17. The method according to claim 13, further comprising the step of machining the joining part after the moving step.
